(19) United States
(12) Patent Application Publication
(10) Pub. No.: US 2018/0081293 A1
(43) Pub. Date: Mar. 22, 2018

(54) LIQUID DEVELOPER AND METHOD FOR PRODUCING THE SAME

(71) Applicant: CANON KABUSHIKI KAISHA, Tokyo (JP)

(72) Inventors: Kenji Nishiguchi, Yokohama-shi (JP); Kei Inoue, Yokohama-shi (JP)

(21) Appl. No.: 15/562,148

(22) PCT Filed: Apr. 20, 2016
(86) PCT No.: PCT/JP2016/063120

§ 371 Date: Sep. 27, 2017

(30) Foreign Application Priority Data
May 27, 2015 (JP) 2015-107664
Mar. 7, 2016 (JP) 2016-043376

(51) Int. Cl. G03G 9/13; G03G 9/125

(52) U.S. Cl. CPC G03G 9/132; G03G 9/125

(57) ABSTRACT

The present invention provides a liquid developer in which a decrease in volume resistivity is suppressed and the stability of the migration of a toner particle is excellent. Therefore, the liquid developer of the present invention is a liquid developer including a toner particle including a colorant and a condensation polymer; and a carrier liquid, wherein the condensation polymer has acid functional groups, and at least some of the acid functional groups form a metallic salt.

### TECHNICAL FIELD

The present invention relates to a liquid developer and a method for producing the same.

### BACKGROUND ART

Conventionally, a dry developer or a liquid developer is used as an electrophotographic developer.

In a liquid developer, an electrically insulating liquid is often used as a carrier liquid. When an electrically insulating liquid is used as a carrier liquid, compared with a dry developer, the problem of the aggregation of a toner particle (colored resin particle) in a liquid developer during storage is less likely to occur, and a fine toner particle can be used. As a result, the advantages of the liquid developer are that the liquid developer has excellent reproducibility of a fine line image, excellent gradation reproducibility, excellent color reproducibility, and also excellent applicability to an image forming method at high speed compared with a dry developer.

The development of a high image quality and high speed digital printing apparatus utilizing an electrophotographic technique using a liquid developer making the most of the excellent advantages is becoming active.

Under such circumstances, the development of a liquid developer having better characteristics is required.

In an electrophotographic image forming method using a liquid developer, an electric field is applied to migrate the charged toner particle in the carrier liquid, thereby developing an electrostatic latent image to perform image formation. Conventionally, the use of a liquid developer containing a charge-controlling agent (also referred to as a charging-controlling agent) for charging a toner particle is proposed.

PTL 1 describes a liquid developer containing a rosin metallic salt compound as a charge-controlling agent, a toner particle including a polyester resin and a colorant, and a carrier liquid. As the metal of the metallic salt, alkali metals, alkaline earth metals, aluminum, and zinc are described.

PTL 2 describes, as a liquid developer including a metallic salt of a resin, a liquid toner for electrostatic charge development including an olefin-based resin containing a carboxy group, and a metallic salt thereof. The technique using the liquid toner is a technique intended to improve fixability to a recording medium into which a carrier liquid does not permeate, such as a plastic film. As the olefin-based resin, ethylene-acrylic acid resins are described.

### CITATION LIST

### Patent Literature

PTL 1: Japanese Patent Application Laid-Open No. 2011-145359
PTL 2: Japanese Patent Application Laid-Open No. H08-36277

### SUMMARY OF INVENTION

### Technical Problem

However, when the liquid developer described in PTL 1 is used, the volume resistivity of the liquid developer decreases and the migration of the toner particle is unstable in some cases depending on the type of the charge-controlling agent.

In addition, when the liquid toner described in PTL 2 is used, the volume resistivity of the liquid toner decreases and the migration of the toner particle is unstable in some cases even if the above particular olefin-based resin and a metallic salt thereof are used.

The present invention is directed to providing a liquid developer in which a decrease in volume resistivity is suppressed and the stability of the migration of a toner particle is excellent and a method for producing the same.

### Solution to Problem

According to one aspect of the present invention, there is provided
a liquid developer including:
a toner particle including a colorant and a condensation polymer; and
a carrier liquid, wherein
the condensation polymer has acid functional groups, and
at least some of the acid functional groups form a metallic salt.

In addition, according to another aspect of the present invention, there is provided
a method for producing a liquid developer including:
a toner particle including a colorant and a condensation polymer; and
a carrier liquid, the method including:
preparing a solution including the condensation polymer with a first solvent for dissolving the condensation polymer;
adding to the solution a second solvent that is a poor solvent for the condensation polymer; and
removing the first solvent.

### Advantageous Effects of Invention

The present invention can provide a liquid developer in which a decrease in volume resistivity is suppressed and the stability of the migration of a toner particle is excellent and a method for producing the same.

### DESCRIPTION OF EMBODIMENTS

Preferred embodiments of the present invention will now be described in detail.

The liquid developer of the present invention is a liquid developer used in an electrophotographic image forming method and is a liquid developer including:
a toner particle including a colorant and a condensation polymer; and
a carrier liquid. The liquid developer of the present invention is characterized in that
the above condensation polymer has acid functional groups, and
at least some of the above acid functional groups form a metallic salt.

In the present invention, the above metallic salt can be at least one metallic salt selected from the group consisting of an alkali metal salt, an alkaline earth metal salt, and an aluminum salt.

In addition, the above acid functional group can be selected from the group consisting of a carboxy group, a sulfo group, and a phosphoric acid group.

In addition, the above carrier liquid can include a vinyl ether compound.

The present inventors have performed the analysis of liquid developers which have low volume resistivity and in which the migration of a toner particle is unstable. As a result, it has been found that among liquid developers, liquid developers having low volume resistivity have a high concentration of a metallic salt compound contained in a carrier liquid.

The present inventors have considered that a metallic salt compound contained in a carrier liquid is a cause of a decrease in volume resistivity and the destabilization of the migration (migration polarity) of a toner particle. Then, the present inventors have found that when a resin (polymer compound) forming a toner particle is a condensation polymer, the above problem can be solved by converting at least some of the acid functional groups that the condensation polymer has into a metallic salt to control the charging properties of the toner particle and suppress the dissolution of a metallic salt compound in a carrier liquid.

[Toner Particle]

The toner particle included in the liquid developer of the present invention is preferably insoluble in the carrier liquid. The toner particle contains a colorant and a condensation polymer as a binder resin.

Examples of the method for producing the toner particle include methods such as a coacervation method and a wet grinding method.

The details of the coacervation method are described in Japanese Patent Application Laid-Open No. 2003-241439, and International Publication No. WO2007/000974 and International Publication No. WO2007/000975, which are republished publications. In addition, the details of the wet grinding method are described in International Publication No. WO2006/126566 and International Publication No. WO2007/108485, which are republished publications.

In the present invention, from the viewpoint of suppressing a decrease in the volume resistivity of the carrier liquid, the coacervation method is preferably used.

The toner particle preferably has an average particle diameter of 0.05 μm or more and 5 μm or less, more preferably 0.05 μm or more and 1 μm or less, from the viewpoint of obtaining a high definition image.

[Condensation Polymer]

In the present invention, for the binder resin of the toner particle, a condensation polymer polymerized via a bond such as an ester bond, an amide bond, a urethane bond, a urea bond, or a carbonate bond is used. Examples of the condensation polymer include polyesters, polyamides, polyurethanes, polyurea, and polycarbonates.

The condensation polymer used in the toner particle included in the liquid developer of the present invention is a condensation polymer having acid functional groups. As the acid functional group of the condensation polymer, a carboxy group, a sulfo group, and a phosphoric acid group are preferred, and from the viewpoint of the suppression of a decrease in the volume resistivity of the liquid developer, a carboxy group and a sulfo group are more preferred.

In the present invention, at least some of the above acid functional groups form a metallic salt. Among metallic salts of acid functional groups, alkali metal salts, alkaline earth metal salts, and aluminum salts are preferred, and from the viewpoint of the suppression of a decrease in the volume resistivity of the liquid developer, potassium salts, sodium salts, lithium salts, calcium salts, and aluminum salts are more preferred.

The molecular weight of the condensation polymer is preferably 1000 or more and 100000 or less in terms of weight average molecular weight and 1000 or more and 50000 or less in terms of number average molecular weight. Both the weight average molecular weight and the number average molecular weight are obtained in terms of polystyrene that is a reference, based on a gel permeation chromatography method (GPC method).

The glass transition point (Tg) of the condensation polymer is measured according to JIS K 7121-2012 using a differential scanning calorimeter. The glass transition point of the condensation polymer is preferably room temperature (25° C.) or more.

The density of the acid functional groups of the condensation polymer is obtained by a potentiometric titration method in which measurement is performed according to JIS K 0070. The acid value of the condensation polymer is preferably in the range of 2 mg KOH/g or more and 50 mg KOH/g or less. As described above, at least some of the acid functional groups of the condensation polymer used in the present invention form a metallic salt.

[Binder Resin]

As the binder resin of the toner particle, other various binder resins can be used in combination in a range that does not impair the effect of the condensation polymer. Examples of the other binder resins include epoxy resins, ester resins, acrylic resins, styrene-acrylic resins, alkyd resins, polyethylene, ethylene-acrylic resins, and rosin-modified resins.

Only one binder resin may be used, or two or more binder resins may be used in combination.

The content of the binder resin in the toner particle is preferably 50 parts by mass or more and 1000 parts by mass or less based on 100 parts by mass of the colorant in the toner particle.

[Colorant]

As the colorant, a pigment is often used.

As the pigment, various organic pigments and inorganic pigments, a dispersion in which a pigment as a dispersion medium is dispersed in an insoluble resin or the like, a pigment on the surface of which a resin is grafted, and the like can be used.

Examples of the pigment include pigments described in Seishiro Ito ed., “Ganryo no Jiten (Dictionary of Pigments)” (published in 2000), W. Herbst, K. Hunger “Industrial Organic Pigments”, Japanese Patent Application Laid-Open No. 2002-12607, Japanese Patent Application Laid-Open No. 2002-188025, Japanese Patent Application Laid-Open No. 2003-26978, and Japanese Patent Application Laid-Open No. 2003-342503.

As the organic pigments and the inorganic pigments, examples of pigments exhibiting a yellow color include the following: C.I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, and 185; and C.I. Vat Yellow 1, 3, and 20.

Examples of pigments exhibiting a red or magenta color include the following: C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, and 269; C.I. Pigment Violet 19; and C.I. Vat Red 1, 2, 10, 13, 15, 23, 29, and 35.

Examples of pigments exhibiting a blue or cyan color include the following: C.I. Pigment Blue 2, 3, 15:2, 15:3, 15:4, 16, and 17; C.I. Vat Blue 6; C.I. Acid Blue 45, and copper phthalocyanine pigments having 1 to 5 phthalimidomethyl groups substituted on a phthalocyanine skeleton.

Examples of pigments exhibiting a green color include C.I. Pigment Green 7, 8, and 36.

Examples of pigments exhibiting an orange color include C.I. Pigment Orange 66 and 51.

Examples of pigments exhibiting a black color include carbon black, titanium black, and aniline black.

Examples of white pigments include basic lead carbonate, zinc oxide, titanium oxide, and strontium titanate.

Titanium oxide has low specific gravity and a high refractive index and is chemically and physically stable compared with other white pigments, and therefore has high hiding power and coloring power as a pigment and has excellent durability against acids, alkalis, and other environments. Therefore, the white pigment can be titanium oxide. Other white pigments (which may be white pigments other than the white pigments listed) may be used as needed.

As the colorant, a dye may be used. A pigment and a dye may be used in combination.

For the dispersion of the pigment, for example, dispersion apparatuses such as ball mills, sand mills, attritors, roll mills, jet mills, homogenizers, paint shakers, kneaders, agitators, Henschel mixers, colloid mills, ultrasonic homogenizers, pearl mills, and wet jet mills can be used.

When the dispersion of the pigment is performed, a dispersing agent may be used.

Examples of the dispersing agent include hydroxy group-containing carboxylates, salts of long chain polyaminoamides and high molecular weight acid esters, salts of high molecular weight polycarboxylic acids, high molecular weight unsaturated acid esters, copolymers, modified polyacrylates, aliphatic polyvalent carboxylic acids, a naphthalenesulfonic acid formalin condensate, polyoxyethylene alkyl phosphates, and pigment derivatives. In addition, commercial polymer dispersing agents such as Solsperse series from Lubrizol can also be used.

In addition, as a dispersion aid, a synergist corresponding to the pigment used can also be used.

1 Part by mass or more and 50 parts by mass or less of each of the dispersing agent and the dispersion aid can be used based on 100 parts by mass of the pigment.

[Carrier Liquid]

The carrier liquid can be a liquid having high volume resistivity, and having low viscosity around room temperature (25° C.). Specific examples of the carrier liquid include hydrocarbon-based solvents such as hexane, heptane, and octane, liquid paraffin-based solvents such as Isopar E and Isopar G (trade names: manufactured by Exxon Mobil Corporation) and MORESCO WHITE P-40 (trade name: manufactured by MORESCO), silicone compounds, and vinyl ether compounds.

The volume resistivity of the carrier liquid is preferably 1×10¹⁰ Ωcm or more and 1×10¹³ Ωcm or less. When the volume resistivity of the carrier liquid is too low, the potential of an electrostatic latent image is likely to change (decrease), and high optical density is less likely to be obtained, and image blurring is likely to be caused. When the volume resistivity of the carrier liquid is too high, the electrophoretic speed of the toner particle decreases, which is likely to lead to a decrease in printing speed.

The viscosity of the carrier liquid is preferably 0.5 or more and less than 10 mPa·s at a temperature of 25° C. When the viscosity of the carrier liquid is too high, the electrophoretic speed of the toner particle decreases, and a decrease in printing speed is likely to be caused.

The material constituting the carrier liquid is preferably a vinyl ether compound from the viewpoint of the suppression of a decrease in volume resistivity.

[Vinyl Ether Compound]

By using a vinyl ether compound having a volume resistivity of 1×10¹⁰ Ωcm or more and 1×10¹³ Ωcm or less for the carrier liquid of the liquid developer of the present invention, a liquid developer having low viscosity and excellent stability of migration polarity can be obtained.

In the present invention, in order for the volume resistivity to fall within the above range, the vinyl ether compound is preferably a vinyl ether compound having no heteroatom except in a vinyl ether group. In the present invention, the heteroatom refers to an atom other than a carbon atom and a hydrogen atom. When a heteroatom is included in the vinyl ether compound, the volume resistivity of the vinyl ether compound is likely to decrease, and the applications are likely to be limited, which is considered to be because due to the difference in electronegativity between the heteroatom and a carbon atom, an locarization in electron density is likely to occur in the molecule of the vinyl ether compound, and an unshared electron pair and an empty electron orbital that the heteroatom has are likely to be the passages of conduction electrons and holes.

In the present invention, in order for the volume resistivity to fall within the above range, the vinyl ether compound can be a vinyl ether compound having no carbon-carbon double bond except in a vinyl ether group. The carbon-carbon double bond has an electron-occupied orbital at a high energy level and an electron-unoccupied orbital at a low energy level. They are likely to be the passages of electrons and holes, which is likely to lead to a decrease in the volume resistivity of the vinyl ether compound. When a double bond other than the double bond of a vinyl ether group is included in the vinyl ether compound, due to the above mechanism, the volume resistivity of the vinyl ether compound is likely to decrease, and the applications are likely to be limited.

By containing a photopolymerization initiator and a photopolymerization sensitizer in the carrier liquid, the liquid developer can also be a photopolymerizable liquid developer. The photopolymerizable initiator and the photopolymerization sensitizer can be a photopolymerizable initiator and a photopolymerization sensitizer that do not decrease the volume resistivity of the liquid developer too much and do not increase the viscosity of the liquid developer too much.

When a liquid developer using a vinyl ether compound as a carrier liquid is photopolymerizable, the vinyl ether compound is preferably a vinyl ether compound having a ring structure in the molecule. By using the vinyl ether compound having a ring structure in the molecule, excellent sensitivity, and strength after curing can be obtained. Examples of the vinyl ether compound having a ring structure in the molecule include aromatic vinyl ether compounds, and vinyl ether compounds having an alicyclic skeleton. Among them, the vinyl ether compound having an alicyclic skeleton is preferred because for an aromatic vinyl ether compound, the volume resistivity is likely to decrease, and the applications are likely to be limited.

As the vinyl ether compound constituting the carrier liquid, a vinyl ether compound having a ring structure in the molecule and a vinyl ether compound having no ring structure in the molecule can also be used in combination. When both are used in combination, the content of the vinyl ether compound having a ring structure in the molecule is preferably 10% by mass or more, more preferably 20% by mass or more, based on the total amount of the vinyl ether compounds. When the content of the vinyl ether compound having a ring structure in the molecule is 10% by mass or less based on the total amount of the vinyl ether compounds, the sensitivity, and the strength after curing are likely to decrease.

[Charging-Controlling Agent]

A charging-controlling agent may be contained in the liquid developer of the present invention as needed.

The charging-controlling agent can be a charging-controlling agent with which the volume resistivity of the liquid developer does not decrease too much and the viscosity of the liquid developer does not increase too much. Examples of the charging-controlling agent include:

oils and fats such as linseed oil and soybean oil; metallic soaps such as alkyd resins, halogen polymers, aromatic polycarboxylic acids, acidic group-containing water-soluble dyes, oxidative condensates of aromatic polyamines, cobalt naphthenate, nickel naphthenate, iron naphthenate, zinc naphthenate, cobalt octylate, nickel octylate, zinc octylate, cobalt dodecylate, nickel dodecylate, zinc dodecylate, aluminum stearate, and cobalt 2-ethylhexanoate;
metallic sulfonates such as petroleum-based metallic sulfonates and metallic salts of sulfosuccinates; phospholipids such as lecithin;
metallic salicylates such as t-butylsalicylic acid metallic complexes; and
polyvinylpyrrolidone resins, polyamide resins, sulfonic acid-containing resins, and hydroxybenzoic acid derivatives.

[Other Additives]

In addition to the above materials, various additives can be used in the liquid developer of the present invention as needed, for the purpose of improvement in recording medium compatibility, storage stability, image storage properties, and other properties. Examples of the additives include surfactants, lubricants, fillers, antifoaming agents, ultraviolet absorbing agents, antioxidants, discoloration inhibitors, fungicides, and rust preventives.

### EXAMPLES

A method for producing a liquid developer according to the present invention will be more specifically described below by Examples. In the following description, “parts” and “%” mean “parts by mass” and “% by mass” respectively unless otherwise noted.

Materials used in the following Examples and Comparative Examples will be described.

(Production of Condensation Polymers)

### Production Example 1

The following materials:

| | | |
|---|---|---|
| an ethylene oxide adduct of bisphenol A (manufactured | 1500 | parts |
| by Sigma-Aldrich Corporation) | | |
| terephthalic acid (manufactured by Sigma-Aldrich | 700 | parts |
| Corporation) | | |

were placed in a round bottom flask equipped with a reflux condenser, a water-alcohol separation apparatus, a nitrogen gas introduction tube, a thermometer, and a stirring apparatus. While the mixture was stirred, nitrogen gas was introduced, and dehydration condensation polymerization/dealcoholization condensation polymerization was performed at a temperature in the range of 200° C. to 240° C.

After a lapse of 1 hour, the temperature of the reaction system was decreased to 100° C. or less to stop the condensation polymerization. A polyester resin A was obtained this way.

The obtained polyester resin A had a weight average molecular weight (hereinafter Mw) of 9000, a number average molecular weight (hereinafter Mn) of 2100, a glass transition point (hereinafter Tg) of 68° C., and an acid value of 12.0 mg KOH/g.

<Method for Measuring Molecular Weight>

The molecular weight of a resin or the like is calculated in terms of polystyrene based on a GPC method as described above. The measurement of molecular weight by GPC is specifically performed as follows.

A sample is added to the following eluent so that the sample concentration is 1.0% by mass. The mixture is allowed to stand at room temperature (25° C.) for 24 hours. The solution in which the sample is dissolved is filtered through a solvent-resistant membrane filter having a pore diameter of 0.20 μm to provide a sample solution, and measurement is performed under the following conditions:

Apparatus: high speed GPC apparatus “HLC-8220GPC” [manufactured by Tosoh Corporation]

### Columns: two of LF-804

Eluent: tetrahydrofuran (THF)
Flow velocity: 1.0 mL/min
Oven temperature: 40° C.
Amount of sample injected: 0.025 mL

In the calculation of the molecular weight of the sample, a molecular weight calibration curve prepared with standard polystyrene resins [TSK Standard Polystyrene F-850, F-450, F-288, F-128, F-80, F-40, F-20, F-10, F-4, F-2, F-1, A-5000, A-2500, A-1000, and A-500 manufactured by Tosoh Corporation] are used.

<Method for Measuring Glass Transition Point>

The glass transition point (Tg) was measured using a differential scanning calorimeter Thermo plus EVO II/DSC8230 (manufactured by Rigaku Corporation). In the measurement, the temperature is increased from −40° C. to 200° C. at 10° C./min, maintained at 200° C. for 5 minutes, then decreased from 200° C. to −40° C. at 10° C./min, maintained at −40° C. for 5 minutes, and increased from −40° C. to 200° C. at 10° C./min again, and from a DSC chart at the time, the glass transition point is obtained.

100 Parts of the polyester resin A was dissolved in 1000 parts of tetrahydrofuran, and 12 parts of a 10% KOH methanol solution was added. The mixture was stirred to convert the acid functional group of the polyester resin A into a potassium salt. The tetrahydrofuran was distilled off by an evaporator. This way, a potassium salt of the polyester resin A (polyester resin A-K) was prepared.

### Production Example 2

A lithium salt of the polyester resin A (polyester resin A-L) was prepared as in Production Example 1 except that after the polyester resin A of Production Example 1 was prepared, 17 parts of a 3% LiOH methanol solution was added instead of 12 parts of a 10% KOH methanol solution.

### Production Example 3

A 10% KOH methanol solution was added to the polyester resin A of Production Example 1, and then 25 parts of a methanol solution of 10% calcium nitrate tetrahydrate was further added to make a calcium salt of the polyester resin A (polyester resin A-C). After washing with hexane, the excess hexane was removed by an evaporator.

### Production Example 4

An aluminum salt of the polyester resin A (polyester resin A-A) was prepared as in Production Example 3 except that in Production Example 3, the methanol solution of 10% calcium nitrate tetrahydrate was changed to 40 parts of a methanol solution of 10% aluminum nitrate nonahydrate.

### Production Example 5

(Making of Potassium N,N′-Bis(hydroxyethyl)-2-aminoethylphosphonate)

The following materials:

| | | |
|---|---|---|
| 2-aminoethylphosphonic acid | 100 | parts |
| potassium hydroxide | 44.9 | parts |
| water | 250 | parts |

were placed in a round bottom flask equipped with a reflux condenser, a nitrogen gas introduction tube, a thermometer, and a stirring apparatus, and stirred at a temperature of 45° C. for 30 minutes.

156 Parts of ethylene oxide was added to the reaction system, and the mixture was further stirred at a temperature of 45° C. for 2 hours. Then, 400 parts of toluene was added, and the mixture was stirred for 10 minutes and then allowed to stand. The lower layer was removed. The obtained lower layer was solidified and dried to obtain potassium N,N′-bis(hydroxyethyl)-2-aminoethylphosphonate.

(Making of Polyester Resin into which Phosphoric Acid Group was Introduced)

The following materials:

| | | |
|---|---|---|
| the polyester resin A | 1000 | parts |
| potassium N,N′-bis(hydroxyethyl)-2- | 100 | parts |
| aminoethylphosphonate | | |

were placed in a round bottom flask equipped with a reflux condenser, a water-alcohol separation apparatus, a nitrogen gas introduction tube, a thermometer, and a stirring apparatus. While the mixture was stirred, nitrogen gas was introduced, and dehydration condensation polymerization/dealcoholization condensation polymerization was performed at a temperature of 200° C. to 240° C.

After a lapse of 1 hour, the temperature of the reaction system was decreased to 100° C. or less to stop the condensation polymerization. This way, a polyester resin B into which a potassium salt of a phosphoric acid group was introduced was obtained.

The obtained polyester resin B had a Mw of 16800, a Mn of 4600, a Tg of 58° C., and an acid value of 13.0 mg KOH/g.

(Making of Polyester Resin Having Zinc Salt of Phosphoric Acid Group)

100 Parts of the polyester resin B was dissolved in 100 parts of tetrahydrofuran, and 80 parts of a 10% zinc nitrate hexahydrate methanol solution was added to convert the phosphoric acid group into a zinc salt. After washing with hexane, the excess hexane was removed by an evaporator. A polyester resin B-Z in which a phosphoric acid group was salified with zinc was prepared.

### Production Example 6

(Making of Potassium N,N′-Bis(hydroxyethyl)-2-aminoethylsulfonate)

The following materials:

| | | |
|---|---|---|
| N,N′-bis(hydroxyethyl)-2-aminoethylsulfonic acid (BES | 213 | parts |
| trade name, manufactured by DOJINDO | | |
| LABORATORIES) | | |
| potassium hydroxide | 56 | parts |
| water | 300 | parts |

were placed in a round bottom flask equipped with a reflux condenser, a nitrogen gas introduction tube, a thermometer, and a stirring apparatus, and stirred at a temperature of 45° C. for 30 minutes.

400 Parts of toluene was added to the reaction system, and the mixture was stirred for 10 minutes and then allowed to stand. The lower layer was removed. The obtained lower layer was solidified and dried to obtain potassium N,N′-bis(hydroxyethyl)-2-aminoethylsulfonate.

(Making of Polyester Resin into which Sulfonic Acid Group was Introduced)

The following materials:

| | | |
|---|---|---|
| the polyester resin A | 1000 | parts |
| potassium N,N′-bis(hydroxyethyl)-2-aminoethylsulfonate | 300 | parts |

were placed in a round bottom flask equipped with a reflux condenser, a water-alcohol separation apparatus, a nitrogen gas introduction tube, a thermometer, and a stirring apparatus. While the mixture was stirred, nitrogen gas was introduced, and dehydration condensation polymerization/dealcoholization condensation polymerization was performed at a temperature of 200° C. to 240° C.

After a lapse of 1 hour, the temperature of the reaction system was decreased to 100° C. or less to stop the condensation polymerization. This way, a polyester resin C-K into which a potassium salt of a sulfonic acid group was introduced was obtained.

The obtained polyester resin C-K had a Mw of 14200, a Mn of 3800, a Tg of 65° C., and an acid value of 18.0 mg KOH/g.

### Production Example 7

(Making of Polyurethane Resin)

(Making of N,N′-Bis(hydroxyethyl)-Glycine Potassium Salt)

The following materials:

| | | |
|---|---|---|
| N,N′-bis(hydroxyethyl)-glycine (Bicine trade name, | 163 | parts |
| manufactured by DOJINDO LABORATORIES) | | |
| potassium hydroxide | 56 | parts |
| water | 300 | parts |

were placed in a round bottom flask equipped with a reflux condenser, a nitrogen gas introduction tube, a thermometer, and a stirring apparatus, and stirred at a temperature of 45° C. for 30 minutes.

400 Parts of toluene was added to the reaction system, and the mixture was stirred for 10 minutes and then allowed to stand. The lower layer was removed. The obtained lower layer was solidified and dried to obtain N,N′-bis(hydroxyethyl)-glycine potassium salt.

(Making of Polyurethane Resin into which Potassium Salt of Carboxy Group was Introduced)

1000 Parts of N-methyl-2-pyrrolidone was placed in a round bottom flask equipped with a reflux condenser, a nitrogen gas introduction tube, a thermometer, and a stirring apparatus, and 150 parts of an ethylene oxide adduct of bisphenol A and 100 parts of diphenylmethane diisocyanate were added. The temperature was kept at 90° C., and the mixture was reacted with stirring for 2 hours. 8 Parts of N,N′-bis(hydroxyethyl)-glycine potassium salt was placed in the reaction system. While the mixture was stirred, nitrogen gas was introduced, and the reaction was performed at a temperature of 90° C. for 2 hours followed by precipitation with hexane. This way, a polyurethane resin D into which a potassium salt of a carboxy group was introduced was obtained.

The obtained polyurethane resin D had a Mw of 18200, a Mn of 5800, a Tg of 73° C., and an acid value of 14.0 mg KOH/g.

### Production Example 8

(Making of Polyamide Resin)

In a glass beaker, 120 parts of hexamethylenediamine was dissolved in 1000 parts of water in which 112 parts of potassium hydroxide was dissolved (solution A). 1000 Parts of hexane was placed in another glass beaker, and 250 parts of dichloride adipate was dissolved (solution B). The solution B was gently poured onto the solution A, and the polyamide resin produced at the interface between the two liquids was removed by a spatula. 1000 Parts of N-methylpyrrolidone was placed in a round bottom flask equipped with a reflux condenser, a nitrogen gas introduction tube, a thermometer, and a stirring apparatus, and 100 parts of the removed polyamide resin and 8 parts of N,N′-bis(hydroxyethyl)-glycine potassium salt were placed. While the mixture was stirred, nitrogen gas was introduced. Dehydration condensation polymerization/dealcoholization condensation polymerization was performed at a temperature of 200° C. to 240° C. After 1 hour, the temperature of the reaction system was decreased to 100° C. or less to stop the condensation polymerization. This way, a polyamide resin E into which a potassium salt of a carboxy group was introduced was obtained.

The obtained polyamide resin E had a Mw of 12500, a Mn of 2800, a Tg of 45° C., and an acid value of 18.0 mg KOH/g.

### Production Example 9

(Making of Polyurea Resin)

(Making of Polyurea Resin into which Potassium Salt of Carboxy Group was Introduced)

1000 Parts of N-methyl-2-pyrrolidone was placed in a round bottom flask equipped with a reflux condenser, a nitrogen gas introduction tube, a thermometer, and a stirring apparatus, and 350 parts of hexamethylenediamine and 1000 parts of diphenylmethane diisocyanate were added. The temperature was kept at 90° C., and the mixture was reacted with stirring for 2 hours. 100 Parts of the above N,N′-bis(hydroxyethyl)-glycine potassium salt was placed in the reaction system. While the mixture was stirred, nitrogen gas was introduced, and the reaction was performed at a temperature of 90° C. for 2 hours followed by precipitation with hexane. This way, a polyurea resin F into which a potassium salt of a carboxy group was introduced was obtained.

The obtained polyurea resin F had a Mw of 15700, a Mn of 4200, a Tg of 53° C., and an acid value of 23.0 mg KOH/g.

### Production Example 10

(Making of Polyurethane Polycarbonate Resin into which Potassium Salt of Carboxy Group was Introduced)

1000 Parts of N-methyl-2-pyrrolidone was placed in a round bottom flask equipped with a reflux condenser, a nitrogen gas introduction tube, a thermometer, and a stirring apparatus, and 1000 parts of polycarbonate diol (T5651 trade name, manufactured by Asahi Kasei Chemicals Corporation) and 350 parts of diphenylmethane diisocyanate were added. The temperature was kept at 90° C., and the mixture was reacted with stirring for 2 hours. 25 Parts of N,N′-bis(hydroxyethyl)-glycine potassium salt was placed in the reaction system. While the mixture was stirred, nitrogen gas was introduced, and the reaction was performed at a temperature of 90° C. for 2 hours followed by precipitation with hexane. This way, a polyurethane polycarbonate resin G into which a potassium salt of a carboxy group was introduced was obtained.

The obtained polyurethane polycarbonate resin G had a Mw of 12200, a Mn of 3800, a Tg of 57° C., and an acid value of 24.0 mg KOH/g.

### Production Example 11

In the making of the polyester resin A of Production Example 1, isophthalic acid, trimellitic acid, propylene oxide-added bisphenol A, and ethylene glycol were used as raw materials in addition to terephthalic acid to make a polyester resin H.

The obtained polyester resin H had a Mw of 28200, a Mn of 2500, a Tg of 58° C., and an acid value of 10 mg KOH/g.

### Example 1

A separable flask was charged with 35 parts of the polyester resin A-K and 65 parts of Isopar G (trade name: manufactured by Exxon Mobil Corporation), a solvent. While the mixture was stirred at 200 rpm by Three-One Motor, the mixture was heated to 130° C. in an oil bath over 1 hour. The mixture was maintained at 130° C. for 1 hour and then slowly cooled at a rate of −15° C. per 1 hour to make a toner particle precursor. The obtained toner particle precursor was in the form of a white paste.

A planetary bead mill (Classic Line P-6/Fritsch) was filled with the following materials:

| | | |
|---|---|---|
| a toner particle precursor | 24 | parts |
| Pigment Blue 15:3 (PV Fast Blue BG: trade name, | 3 | parts |
| manufactured by Clariant) as a pigment | | |
| Isopar G, a solvent | 8 | parts |

together with zirconia beads having a diameter of 0.5 mm. The mixture was ground at 200 rpm at room temperature for 4 hours to obtain a toner particle dispersion (solids 27% by mass).

The volume average particle diameter of the obtained toner particle was 1.8 μm (measured by LA950 manufactured by HORIBA, Ltd.).

20 Parts of the solvent Isopar G was added to 10.0 parts of the toner particle dispersion to obtain a liquid developer 1.

### Examples 2 to 11 and Comparative Example 1

In Examples 2 to 11 and Comparative Example 1, liquid developers 2 to 11 and a liquid developer 12 were prepared by replacing the materials of Example 1 with the materials described in Table 1.

TABLE 1

| | | | Pigment | | | Dispersion |
|---|---|---|---|---|---|---|
| Example | Developer | Resin | CI No. | Product name | Solvent | method |
| Example 1 | Developer 1 | Polyester resin A-K | Pigment Blue | Clariant PV Fast Blue | Isopar G | Wet |
| | | | 15:3 | BG | | dispersion |
| Example 2 | Developer 2 | Polyester resin A-L | Pigment Blue | Clariant PV Fast Blue | Isopar G | Wet |
| | | | 15:3 | BG | | dispersion |
| Example 3 | Developer 3 | Polyester resin A-C | Pigment Blue | Clariant PV Fast Blue | Isopar G | Wet |
| | | | 15:3 | BG | | dispersion |
| Example 4 | Developer 4 | Polyester resin A-A | Pigment Blue | Clariant PV Fast Blue | Isopar G | Wet |
| | | | 15:3 | BG | | dispersion |
| Example 5 | Developer 5 | Polyester resin B-Z | Pigment Red | Clariant Toner | Isopar G | Wet |
| | | | 122 | Magenta E | | dispersion |
| Example 6 | Developer 6 | Polyester resin C | Pigment Yellow | Clariant Toner | Isopar G | Wet |
| | | | 180 | Yellow HG | | dispersion |
| Example 7 | Developer 7 | Polyester resin B | Pigment Black 7 | Mitsubishi Chemical | Isopar G | Wet |
| | | | | Corporation MA600 | | dispersion |
| Example 8 | Developer 8 | Polyurethane resin D | Pigment Blue | Clariant PV Fast Blue | Isopar G | Wet |
| | | | 15:3 | BG | | dispersion |
| Example 9 | Developer 9 | Polyamide resin E | Pigment Blue | Clariant PV Fast Blue | Isopar G | Wet |
| | | | 15:3 | BG | | dispersion |
| Example 10 | Developer | Polyurea resin F | Pigment Blue | Clariant PV Fast Blue | Isopar G | Wet |
| | 10 | | 15:3 | BG | | dispersion |
| Example 11 | Developer | Polyester polycarbonate | Pigment Blue | Clariant PV Fast Blue | Isopar G | Wet |
| | 11 | resin G | 15:3 | BG | | dispersion |
| Comparative | Developer | Polyester resin A | Pigment Blue | Clariant PV Fast Blue | Isopar G | Wet |
| Example 1 | 12 | | 15:3 | BG | | dispersion |

In Table 1, the liquid developers 2 to 11 and the liquid developer 12 are simply described as Developers 1 to 11 and Developer 12.

### Examples 12 and 13

In Example 12, a liquid developer 13 was prepared as in Example 1 except that the solvent was changed from Isopar G to dodecyl vinyl ether, a vinyl ether compound.

In Example 13, a liquid developer 14 was prepared as in Example 1 except that the solvent was changed from Isopar G to polyethylene glycol vinyl ether, a vinyl ether compound.

### Example 14

In Example 14, a liquid developer 15 was prepared by a coacervation method.

The coacervation method is a method in which a poor solvent (second solvent) is added to a solution of a resin dissolved in a good solvent (first solvent) to decrease the solubility of the resin, and shear or the like is applied to form a particle of the deposited resin. When a particle is formed, a pigment (pigment particle) is previously dispersed, and included in a particle to form a toner particle.

(Pigment Dispersion Step)

The following materials:

| | |
|---|---|
| Pigment Blue 15:3 (PV Fast Blue BG: trade name, | 3 parts |
| manufactured by Clariant) as a pigment | |
| Solsperse 13940 (trade name, manufactured by Lubrizol) | 7.5 parts |
| as a pigment-dispersing agent | |
| tetrahydrofuran (hereinafter also described as “THF”) | 4.5 parts |
| as a solvent | |

were mixed, and stirred at 500 rpm by Three-One Motor. Then, dispersion treatment was performed by Alpha Mill-model 03L (trade name: manufactured by AIMEX CO., Ltd.) under the condition of a number of revolutions of 1500 rpm for 2 hours using 0.05 mm zirconia beads to make a pigment dispersion 1.

(Coacervation Step)

12 Parts of the polyester resin A-K was dissolved in 42 parts of THF in a glass beaker, and 10 parts of the above pigment dispersion 1 from which the zirconia beads were removed was added. The glass beaker was ice-cooled, and while the mixture was stirred under the condition of 15000 rpm using Three-One Motor, 48 parts of Isopar G was added at a flow rate of 0.2 mL/min using Perista Pump AC-2110II (manufactured by ATTO CORPORATION). After the addition, the mixed liquid was transferred to a round bottom flask. Using an evaporator and using a water bath, the THF was completely distilled off under reduced pressure while the liquid temperature in the round bottom flask was kept at 50° C., thereby obtaining the liquid developer 15.

### Example 15

A liquid developer 16 was prepared as in Example 14 except that Isopar G was changed to dodecyl vinyl ether.

### Example 16

A liquid developer 17 was prepared as in Example 15 except that the polyester resin A-K was changed to the polyester resin C-K into which a potassium salt of a sulfonic acid group was introduced.

### Comparative Example 2

A liquid developer 18 including an olefin-based resin containing a carboxy group, and a metallic salt of an olefin-based resin containing a carboxy group was prepared using materials described in Example 1 of PTL 2.

Specifically, with a mixture of the following materials:

| | |
|---|---|
| a polyethylene-methacrylic acid copolymer (Nucrel 925, | 9% |
| trade name, manufactured by DuPont) | |
| ethylene methacrylic acid copolymer Na salt | 4% |
| (manufactured by DUPONT-MITSUI POLYCHEMICALS CO., | |
| LTD.) | |
| carbon black (MA285 trade name, manufactured by | 4% |
| Mitsubishi Chemical Corporation) | |
| Isopar H (manufactured by Exxon Mobil Corporation) | 83%, |

circulation operation was performed for 20 hours using a wet dispersion machine (DYNO-MILL Multi-Lab: manufactured by SHINMARU ENTERPRISES CORPORATION) to perform wet grinding. The slurry after the grinding was removed and passed through a mesh having an opening of 33 μm (made of SUS304) to obtain a liquid developer 18.

### Comparative Example 3

A liquid developer 19 was prepared using materials described in Example 1 of PTL 1.

Specifically, the following materials:

| the polyester resin H | 52 | parts |
|---|---|---|
| a rosin metallic salt compound, PINECRYSTAL | 8 parts (metal: | |
| KR-50M manufactured by Arakawa Chemical | calcium) | |
| Industries, Ltd. | | |
| carbon black, MONARCH 280 manufactured by Cabot | 37 | parts |
| Copy Blue PR manufactured by Clariant | 3 | parts |

were mixed in a pressure kneader (D0.5-3: manufactured by Moriyama) at a set temperature of 150° C. for 10 minutes and further kneaded by a three-roll mill (BR-100V: manufactured by AIMEX CO., Ltd.) at a roll temperature of 95° C. The mixture was cooled and then crushed to 10 mm or less to obtain a black conc. 1.

Next, the following materials:

| | |
|---|---|
| the polyester resin H | 50 parts |
| the black conc. 1 | 50 parts |

were mixed by a Henschel mixer (FM-10C/I: manufactured by NIPPON COKE & ENGINEERING COMPANY, LIMITED) at 3000 rpm for 3 minutes, then melted and kneaded by a twin-screw kneading extruder (PCM30: manufactured by Ikegai Corp) under the conditions of 6 kg/h and a discharge temperature of 145° C., and cooled and solidified. Then, the mixture was coarsely ground by a hammer mill (TAP-1: manufactured by Seishin Enterprise Co., Ltd.) and then finely ground by an I type jet mill (model IDS-2: manufactured by Nippon Pneumatic Mfg. Co., Ltd.) to obtain a black toner ground article 1 having 5.0 μm in volume average particle diameter.

Further, the following materials:

| | | |
|---|---|---|
| the black toner ground article 1 | 25 | parts |
| Isopar M | 73 | parts |
| Lubrizol 2153 (manufactured by Lubrizol) | 2 | parts |

were mixed, and circulation operation was performed for 60 minutes using a wet dispersion machine (DYNO-MILL Multi-Lab: manufactured by SHINMARU ENTERPRISES CORPORATION) to perform wet grinding. The slurry after the grinding was removed and passed through a mesh having an opening of 33 μm (made of SUS304). 1 Part of Lubrizol 2153 was added to 100 parts of the slurry, and the mixture was stirred to obtain a liquid developer 19.

[Evaluation]

The liquid developers prepared were evaluated as follows.

(Migration Speed)

For the mobility of the liquid developer prepared, the state of the migration of the toner particle when a potential difference of 100 V was applied between 100 μm spaced and opposed parallel plate electrodes was filmed by a video camera connected to an optical microscope, and the average migration speed of the observed toner particle was evaluated by image processing. As the migration polarity becomes more stable, the migration speed becomes faster because the toner particle migrates in the same direction.

The evaluations were performed according to criteria in Table 2, and A to C were considered as the effect of the present invention being obtained.

TABLE 2

| | Migration speed (m²/Vs) |
|---|---|
| A | 1 × 10⁻¹⁰ or more and less than 5 × 10⁻¹⁰ |
| B | 5 × 10⁻¹¹ or more and less than 1 × 10⁻¹⁰ |
| C | 1 × 10⁻¹¹ or more and less than 5 × 10⁻¹¹ |
| D | Less than 1 × 10⁻¹¹ |
| E | Migration direction is unclear |

(Volume Resistivity)

The volume resistivity of the liquid developer prepared was measured by applying a potential difference of 100 V between 1 mm spaced electrodes (DAC-OBE-2: manufactured by Soken Electric Co., Ltd.).

The evaluations were performed according to criteria in Table 3, and A to D were considered as the effect of the present invention being obtained.

TABLE 3

| | Volume resistivity (Ωcm) |
|---|---|
| A | 1 × 10⁺¹² or more |
| B | 1 × 10⁺¹¹ or more and less than 1 × 10⁺¹² |
| C | 5 × 10⁺¹⁰ or more and less than 1 × 10⁺¹¹ |
| D | 1 × 10⁺¹⁰ or more and less than 5 × 10⁺¹⁰ |
| E | Less than 1 × 10⁺¹⁰ |

The evaluation results are shown in Table 4.

TABLE 4

| | | Migration speed | Volume |
|---|---|---|---|
| | | m²/Vs | resistivity Ωcm |
| Example 1 | Liquid developer 1 | B | C |
| Example 2 | Liquid developer 2 | B | C |
| Example 3 | Liquid developer 3 | B | C |
| Example 4 | Liquid developer 4 | B | C |
| Example 5 | Liquid developer 5 | C | D |
| Example 6 | Liquid developer 6 | B | D |
| Example 7 | Liquid developer 7 | B | D |
| Example 8 | Liquid developer 8 | B | C |
| Example 9 | Liquid developer 9 | B | C |
| Example 10 | Liquid developer 10 | B | C |
| Example 11 | Liquid developer 11 | B | C |
| Example 12 | Liquid developer 13 | A | B |
| Example 13 | Liquid developer 14 | B | B |
| Example 14 | Liquid developer 15 | B | B |
| Example 15 | Liquid developer 16 | A | A |
| Example 16 | Liquid developer 17 | A | A |
| Comparative | Liquid developer 12 | E | A |
| Example 1 | | | |
| Comparative | Liquid developer 18 | D | E |
| Example 2 | | | |
| Comparative | Liquid developer 19 | D | E |
| Example 3 | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2015-107664, filed May 27, 2015 and No. 2016-043376, filed Mar. 7, 2016, which are hereby incorporated by reference herein in their entirety.

1. A liquid developer comprising:
a toner particle comprising a colorant and a condensation polymer; and
a carrier liquid, wherein
the condensation polymer has acid functional groups, and
at least some of the acid functional groups form a metallic salt, and wherein
the carrier liquid comprises a vinyl ether compound.

2. The liquid developer according to claim 1, wherein the metallic salt is at least one metallic salt selected from the group consisting of an alkali metal salt, an alkaline earth metal salt, and an aluminum salt.

3. The liquid developer according to claim 1, wherein the acid functional group is selected from the group consisting of a carboxy group, a sulfo group, and a phosphoric acid group.

4. The liquid developer according to claim 3, wherein the acid functional group is a carboxy group or a sulfo group.

5. (canceled)

6. A method for producing a liquid developer comprising:
a toner particle comprising a colorant and a condensation polymer; and
a carrier liquid, the method comprising:
preparing a solution comprising the condensation polymer with a first solvent for dissolving the condensation polymer;
adding to the solution a second solvent that is a poor solvent for the condensation polymer; and
removing the first solvent, wherein
the second solvent is a vinyl ether compound.

7. (canceled)

8. The liquid developer according to claim 2, wherein the acid functional group is selected from the group consisting of a carboxy group, a sulfo group, and a phosphoric acid group.

9. The liquid developer according to claim 2, wherein the acid functional group is a carboxy group or a sulfo group.

10. The liquid developer according to claim 8, wherein the acid functional group is a carboxy group or a sulfo group.
